(19) United States
(12) Patent Application Publication
(10) Pub. No.: US 2009/0215963 A1
(43) Pub. Date: Aug. 27, 2009

(54) Thermoplastic elastomeric material and process for its manufacturing

(76) Inventors: Serena Coiai, Pontasserchio (IT); Elisa Passaglia, Pisa (IT); Catherine Hirel, Grenoble (FR); Francesco Ciardelli, Pisa (IT); Diego Tirelli, Milano (IT); Emiliano Resmini, Milano (IT); Franco Peruzzotti, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/659,319

(22) PCT Filed: Aug. 4, 2004
(86) PCT No.: PCT/EP2004/008735

§ 371 Date: Apr. 7, 2009

(51) Int. Cl. C08L 41/00; B32B 5/16; C08F 273/00

(52) U.S. Cl. 525/212; 428/402; 525/242; 525/244; 525/266; 525/264; 525/254; 525/260

(57) ABSTRACT

A thermoplastic elastomeric material includes a vulcanized rubber in a subdivided form surface-grafted with at least one vinyl polymer, wherein the amount of the surface-grafted vinyl polymer is not lower than 60% by weight, preferably not lower than 70% by weight, more preferably not lower than 80% by weight, with respect to the total weight of the surface-grafted vinyl polymer and the vulcanized rubber in a subdivided form.

The present invention relates to a thermoplastic elastomeric material.

In particular, the present invention relates to a thermoplastic elastomeric material comprising a vulcanized rubber in a subdivided form surface-grafted with at least one vinyl polymer.

The present invention moreover relates to a process for manufacturing said thermoplastic elastomeric material, said process comprising a free radical polymerization of vinyl monomers in the presence of a vulcanized rubber in a subdivided form.

In a further aspect, the present invention also relates to a manufactured product including said thermoplastic elastomeric material.

The increased production of industrial rubber products has resulted in the accumulation of large amounts of rubber wastes which are generally disposed in dedicated landfills with the main drawbacks of environment pollution as well as of the need for large dedicated areas for storing said wastes.

It is known in the art to depolymerize waste rubber, such as tyres, in an effort to reduce the volume of waste and obtain a useful byproduct. Likewise, rubber products may be devulcanized in an attempt to recycle the waste rubber.

In addition to these techniques, it is common in the art to grind the waste rubber and utilize the ground particles so obtained. These ground particles may then be compounded with thermoplastic polymeric materials in order to make final products which may be employed in a plurality of applications.

Said ground particles may be added to substantially thermoplastic polymers such as, for example, polypropylene or polystyrene, to improve their impact strength.

For example, the article of D. Tuchman and S. L. Rosen published in “Journal of Elastomers and Plastics”, Vol. 10, pp. 115-128 (1978), discloses the addition of cryogenically ground tyre rubber to various thermoplastic polymers including polypropylene and polystyrene. In particular, with regard to polystyrene, the authors said that the cryogenically ground tyre rubber acts a moderately good impact enhancer when mechanically blended with polystyrene. A mechanical blend comprising 20% by weight of cryogenically ground tyre rubber produces a material mechanically comparable to a medium impact polystyrene. Moreover, the authors have investigated several techniques in order to graft styrene to the cryogenically ground tyre rubber. To this aim, different techniques were investigated such as, bulk graft, free radical graft and acid graft. The authors said that only an aqueous slurry process using a water-soluble initiator system was successful in giving a product having improved impact strength with respect to a product obtained by a straight mechanical blend.

U.S. Pat. No. 3,042,634 discloses a process of making a rubber-resin product which comprises heating a mixture comprising comminuted rubber that has been vulcanized, water and resin-forming monomeric material selected from the group consisting of monoolefins such as, for example, styrene, α-methyl styrene, and acrylonitrile, and mixtures of such monoolefins, with material selected from the group consisting of butadiene and divinyl benzene, in an amount up to one-fourth the weight of said monoolefins, at a temperature of from 125° C. to 250° C., until polymerization of said monomeric material, and recovering a dry-rubber resin product therefrom that may be masticated to give a uniform smooth rubber-resin blend. The abovementioned rubber-resin product is said to range from a stiffened rubbery product at the lower styrene monomer charge to a rigid brittle gum plastic at high styrene monomer charge.

Patent application GB 2,022,105 discloses a method of making plastic materials incorporating reclaimed tyre rubber which comprises swelling said reclaimed tyre rubber with a quantity of monomer which is insufficient to saturate said reclaimed tyre rubber and polymerizing the swollen mass. Monomers which may be conveniently used are selected from: vinyl aromatic compounds such as, for example, styrene, or substituted styrenes (for example, β-bromostyrene, chlorostyrene); acrylonitrile; divinyl benzene; or mixtures thereof. The obtained plastic materials are said to have good impact strength, tensile strength and elongation at break.

The article of M. Pittolo and R. P. Burford published in “Journal of Material Science”, Vol. 21, pp. 1769-1774 (1986), discloses a study on rubber-crumb modified polystyrene. In particular, peroxide crosslinked polybutadiene and styrene/butadiene rubber powders were converted to semi-interpenetrating networks by swelling in styrene monomer and subsequent homopolymerization. Two initiator types were selected, one causing bonding between polystyrene and the rubber (benzoyl peroxide), the other allowing independent polymerization [azobis(isobutyro-nitrile)]. The polystyrene modified powders were then incorporated into a polystyrene matrix and the tensile properties of the resulting composites were determined. Improvements in performance over untreated crumb-modified composites were observed, with increased breaking strains due to crazing.

The article of M. Pittolo and R. P. Burford published in “Rubber Chemistry and Technology”, Vol. 58, pp. 97-106 (1986), discloses the use of recycled rubber-crumb as thoughener of polystyrene. In particular, the rubber-crumb were treated with styrene monomer and benzoyl peroxide in order to graft the polystyrene on the rubber-crumb surface. The obtained modified rubber-crumb was then incorporated into a polystyrene matrix obtaining a composite material. The toughness of the obtained composite material is said to increase with increasing rubber-to-matrix adhesion and decreasing particle size of the rubber-crumb.

The paper “Free radical polymerization of vinyl monomers in the presence of ground tyre rubber” presented by S. Coiai et al. at the conference “Macromolecules 2003” held at Tirrenia (Pisa), Italy, on 6-16 Oct., 2003, discloses the possibility of providing some transfer groups onto the ground rubber surface in order to increase the grafted polymer content. No mention is made about the type of transfer groups which may be advantageously used.

The Applicant has faced the problem of improving the impact strength of thermoplastic elastomeric materials incorporating vulcanized ground rubber. In particular, the Applicant has faced the problem of improving the impact strength of thermoplastic elastomeric materials comprising a vulcanized ground rubber surface-grafted with at least one vinyl polymer.

The Applicant has now found that it is possible to improve said impact strength by increasing the amount of said surface-grafted vinyl polymer. The increased amount of the surface-grafted vinyl polymer allows to obtain thermoplastic elastomeric materials showing an improved impact strength which may be directly used in order to make manufactured products. Moreover, said thermoplastic elastomeric materials may be used in blends with other polymeric materials, in particular with polymeric materials having the same kind of polymeric chains (e.g. vinyl polymer chains), in order to improve their impact strength.

According to a first aspect, the present invention relates to a thermoplastic elastomeric material comprising a vulcanized rubber in a subdivided form surface-grafted with at least one vinyl polymer, wherein the amount of said surface-grafted vinyl polymer is not lower than 60% by weight, preferably not lower than 70% by weight, more preferably not lower than 80% by weight, with respect to the total weight of the surface-grafted vinyl polymer and the vulcanized rubber in a subdivided form.

Generally, the amount of said surface grafted vinyl polymer is not higher than 99.9% by weight, preferably not higher than 95% by weight, with respect to the weight of the thermoplastic elastomeric material after extraction of the ungrafted vinyl polymer.

The amount of the surface-grafted vinyl polymer may be determined by means of the following formula:

$$\% of surface grafted vinyl polymer = \frac{( WGV )}{( WAE )} \times 100$$

wherein:
WGV is the weight, expressed in grams (g), of the surface-grafted vinyl polymer;
WAE is the weight, expressed in grams (g), of the obtained thermoplastic elastomeric material after extraction of the ungrafted vinyl polymer.

The weight of the surface-grafted vinyl polymer may be determined by means of gravimetric analysis by mass balance: further details about said analysis will be reported in the examples which follow.

The extraction of the ungrafted vinyl polymer may be carried out by means of processes known in the art such as, for example, by solvent extraction: further details about the extraction process will be reported in the examples which follow.

Preferably, the Degree of Grafting (DG) (%) of said vinyl polymer onto the surface of said vulcanized rubber in a subdivided form is not lower than 150%, preferably of from 160% to 600%, more preferably of from 180% to 800%.

The Degree of Grafting (DG) may be determined according to the article of M. Pittolo and R. P. Burford published in “Rubber Chemistry and Technology” above reported, by means of the following formula:

$$\% DG = \frac{( WAE - WRS )}{( WRS )} \times 100$$

wherein:
WAE is the weight, expressed in grams (g), of the obtained thermoplastic elastomeric material after extraction of the ungrafted vinyl polymer;
WRS is the weight, expressed in grams (g), of the vulcanized rubber in a subdivided form in the obtained thermoplastic elastomeric material.

Further details about the determination of the Degree of Grafting will be reported in the examples which follow.

According to one preferred embodiment, said vinyl polymer is grafted onto the surface of the vulcanized rubber in a subdivided form by means of a sulfur bridge (—S— bridge).

According to a further aspect, the present invention also relates to a process for manufacturing a thermoplastic elastomeric material, said process comprising the following steps:
surface treating a vulcanized rubber in a subdivided form in order to provide hydroxy and/or mercapto groups on its surface;
grafting at least one vinyl monomer to said surface-treated vulcanized rubber in the presence of at least one free radical initiator so as to obtain a vinyl polymer grafted onto the surface of said vulcanized rubber in a subdivided form.

Preferably, said vulcanized rubber in a subdivided form is surface-treated in order to provide mercapto groups on its surface.

Preferably, the grafting efficiency (Φ) of said vinyl polymer onto the surface of said vulcanized rubber is not lower than 40%, preferably of from 45% to 60%, more preferably of from 50% to 80%.

Said grafting efficiency (Φ) may determined by the means of the following formula:

$$( Φ ) = \frac{( WGV )}{( WTV )} \times 100$$

wherein:
WGV is the weight, expressed in grams (g), of the surface-grafted vinyl polymer;
WTV is the total weight, expressed in grams (g), of the vinyl polymer contained in the obtained thermoplastic elastomeric material.

For the aim of the present description and of the claims which follow, with the expression “the total weight of the vinyl polymer contained in the obtained thermoplastic elastomeric material” it is intended the sum between the weight of the surface-grafted vinyl polymer and the weight of the ungrafted vinyl polymer present in the obtained thermoplastic elastomeric material. Said weight may be determined by means of a gravimetric analysis by mass balance: further details about said analysis will be reported in the examples which follow.

For the purpose of the present description and of the claims which follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

The vulcanized rubber in a subdivided form which may be used in the present invention may be obtained by grinding or otherwise comminuting any source of vulcanized rubber compound such as, for example, tyres, roofing membranes, hoses, gaskets, and the like, and is preferably obtained from reclaimed or scrap tyres using any conventional method. For example, the vulcanized rubber in a subdivided form may be obtained by mechanical grinding at ambient temperature or in the presence of a cryogenic coolant (i.e. liquid nitrogen). Any steel or other metallic inclusions should be removed from the ground tyres before use. Usually, fibrous material such as, for example, tyre cord fibers, is preferably removed from the ground rubber using conventional separation methods.

According to one preferred embodiment, the vulcanized rubber in a subdivided form which may be used in the present invention, is in the form of powder or granules having a particle size not higher than 10 mm, preferably not higher than 5 mm.

According to a more preferred embodiment, the vulcanized rubber in a subdivided form which may be used in the present invention, has a particle size not higher than 0.5 mm, preferably not higher than 0.2 mm, more preferably not higher than 0.1 mm.

According to one preferred embodiment, the vulcanized rubber in a subdivided form may comprise at least one crosslinked diene elastomeric polymer or copolymer which may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the crosslinked diene elastomeric polymer or copolymer may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

Alternatively, the vulcanized rubber in a subdivided form may further comprise at least one crosslinked elastomeric polymer of one or more monoolefins with an olefinic comonomer or derivatives thereof. The monoolefins may be selected, for example, from: ethylene and α-olefins generally containing from 3 to 12 carbon atoms such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

The surface-grafted vinyl polymer may be obtained by means of a free radical polymerization of vinyl monomers in the presence of a vulcanized rubber in a subdivided form. Preferably, said vinyl monomers may be selected, for example, from: alkyl vinyl monomers such as 2-hydroxyethyl(meth)acrylate, 2-hydroxypropyl(meth)acrylate, 2-ethylhexyl(meth)acrylate, butoxyethyl(meth)acrylate; cyclic vinyl monomers such as tetrahydrofurfuryl(meth)acrylate; linear or branched alkyl(meth)acrylates such as methyl(meth)acrylate, ethyl(meth)acrylate, butyl(meth)acrylate, octyl(meth)acrylate, decyl(meth)acrylate, tridecyl(meth)acrylate, stearyl(meth)acrylate, lauryl(meth)acrylate, isodecyl(meth)acrylate), n-hexyl(meth)-acrylate; cyclic(meth)acrylates such as cyclohexyl(meth)acrylate, isobornyl(meth)acrylate; ethoxylated alkyl(meth)acrylates such as methoxyethyl(meth)acrylate, ethoxyethyl(meth)acrylate, butoxyethyl(meth)acrylate, 2-(2-ethoxy)ethyl(meth)acrylate; dicyclopentenyl(meth)-acrylate; diethylene glycol(meth)acrylate; ethoxy-diethylene glycol(meth)acrylate; benzyl(meth)acrylate; polyethylene glycol(meth)acrylate; polypropylene glycol(meth)acrylate; methoxypolyethylene glycol(meth)acrylate; methoxypolypropylene glycol(meth)acrylate; 2-phenoxyethyl(meth)acrylate; phenoxypolyethylene glycol(meth)acrylate; alkylphenoxyethyl(meth)acrylate such as nonylphenoxyethyl(meth)acrylate; alkylphenoxypolyalkylene glycol(meth)acrylate; 2-hydroxy-3-phenyloxypropyl(meth)-acrylate; tetra-hydrofurfuryloxypropylalkylene glycol(meth)acrylate; dicyclopentenyloxypolyalkylene glycol(meth)acrylate; polyfluoroalkyl(meth)acrylate; or mixtures thereof; or from aromatic vinyl monomers such as styrene; o-methylstyrene; m-methylstyrene; p-methyl-styrene; 2,4-dimethylstyrene; ethylstyrene; p-t-butyl-styrene; α-methyl-styrene; α-methyl-p-methylstyrene; o-chlorostyrene; m-chlorostyrene; p-chlorostyrene; p-bromostyrene; 2-methyl-1,4-dichlorostyrene; 2,4-dibromo-styrene; vinylnaphthalene; or mixture thereof; or derivatives thereof including styrene monomers containing copolymerizable monomer as a substituent such as, for example, acrylonitrile, maleic anhydride, methyl methacrylate, vinyl acetate, divinylbenzene, or mixtures thereof. Methyl(meth)acrylate or styrene monomers are preferred. Styrene is particularly preferred.

With regard to the process for manufacturing a thermoplastic elastomeric material, the step of providing hydroxy groups and/or mercapto groups on the surface of the vulcanized rubber in a subdivided form may be carried out in different ways.

For example, the step of surface treating a vulcanized rubber in a subdivided form in order to provide hydroxy groups on its surface, may be carried out by dispersing said vulcanized rubber in a subdivided form in a mixture comprising water and an organic solvent with at least one oxidizing agent.

Preferably, the organic solvent may be selected, for example, from: ketones such as acetone; alcohols such as ethanol, methanol; ethers such as tetrahydrofurane, dioxane; or mixtures thereof. Acetone aqueous solution (10% acetone/90% water) is particularly preferred.

Preferably, the oxidizing agent may be selected, for example from: potassium permanganate, hydrogen peroxide, osmium tetraoxide, hydrogen peroxide/urea complex, sodium percarbonate, sodium perchlorate, sodium perborate, potassium peroxymonosulfate, potassium permanganate/potassium periodate aqueous solution, or mixtures thereof. Potassium permanganate is particularly preferred.

Preferably, said surface treating step may be carried out at a temperature of from −15° C. to 50° C., more preferably of from 0° C. to 30° C., for a time of from 1 hour to 48 hours, more preferably of from 18 hours to 30 hours.

Preferably, the oxidizing agent is used in an amount of from 1% by weight to 50% by weight, preferably of from 10% by weight to 25% by weight, with respect to the total weight of the vulcanized rubber in a subdivided form.

The step of surface treating a vulcanized rubber in a subdivided form in order to provide mercapto groups on its surface may be carried out as follows.

For example, the vulcanized rubber surface-treated as above disclosed in order to provide hydroxy groups on its surface, may be reacted with at least one silane coupling agent in order to provide mercapto groups on its surface.

Preferably, the silane coupling agent may be selected, for example, from compounds having the following structural formula (I):

(R)₃Si—CₙH₂ₙ—SH (I)

wherein the groups R, which may be identical or different, are selected from: alkyl, alkoxy or aryloxy groups or from halogen atoms, on condition that at least one of the groups R is an alkoxy or aryloxy group; n is an integer of from 1 to 6 inclusive.

Preferably, the coupling agents may be selected, for example, from: (3-mercaptopropyl)trimethoxysilane, (3-mercaptopropyl)dimethoxymethylsilane, (3-mercaptopropyl)-triethoxysilane, (3-mercaptopropyl)diethoxymethylsilane, (3-mercaptopropyl)methoxydimethylsilane, (4-mercaptobutyl)-trimethoxysilane, (4-mercaptobutyl)diethoxymethylsilane, or mixtures thereof. (3-Mercaptopropyl)trimethoxysilane is particularly preferred.

Preferably, the reaction with at least one coupling agent may be carried out at a temperature of from −10° C. to 150° C., more preferably of from 80° C. to 100° C., for a time of from 1 hour to 48 hours, more preferably of from 18 hours to 30 hours.

Preferably, the coupling agent is used in an amount of from 0.01% by weight to 10% by weight, preferably of from 0.8% by weight to 2% by weight, with respect to the total weight of the surface-treated vulcanized rubber.

Alternatively, the mercapto groups may be provided on the surface of the vulcanized rubber in a subdivided form by reacting the same with at least one thio-acid having the following structural formula (II):

R₁—C(═O)—SH (II)

wherein R₁ is selected from alkyl, aryl, alkylaryl or arylalkyl groups, in the presence of at least one free radical initiator.

Preferably, the thio-acid may be selected, for example, from: thioacetic acid, thiopropionic acid, thiobenzoic acid, or mixtures thereof. Thioacetic acid is particularly preferred.

Preferably, the thio-acid is used in an amount of from 0.01% by weight to 3% by weight, preferably of from 0.1% by weight to 1% by weight, with respect to the total weight of the vulcanized rubber in a subdivided form.

Preferably, the free radical initiator may be selected from azo compounds having the following structural formula (III):

R₂—N═N—R₃ (III)

wherein R₂ and R₃, which may be identical or different, may be selected from organic groups such as, for example, aliphatic, cycloaliphatic, or aromatic groups; or linear or cyclic nitrile derivatives.

Preferably, the free radical initiator may be selected, for example, from: 1,1′-azobis(cyclohexane-carbonitrile), azodicarbonamide, 2,2′-azobis(2,4-dimethyl-pentenenitrile), 2,2′-azobis(2-ethylpropanimide-amide).2HCl, 2,2′-azobis(isobutyronitrile), 2,2′-azobis(2-methylbutanenitrile), 4,4′-azobis(4-cyanopentanoic acid), 2,2′-azobis(2-acetoxypropane), 2-(t-butylazo)-4-methoxy-2,4-dimethylpentanenitrile, 2-(t-butylazo)-2,4-dimethyl-pentanenitrile, 4-(t-butylazo)-4-cyanopentanoic acid, 2-(t-butylazo)isobutyronitrile, 2-(t-butylazo)-2-methyl-butanenitrile, 1-(t-amylazo)cyclohexanecarbonitrile, 1-(t-butylazo)cyclohexanecarbonitrile, 1-(t-butylazo)formamide, or mixtures thereof. 2,2′-Azobis(isobutyronitrile) is particularly preferred.

Preferably, the free radical initiator is used in an amount of from 0.001% by weight to 10% by weight, preferably of from 0.005% by weight to 5% by weight, with respect to the total weight of the vulcanized rubber in a subdivided form.

Preferably, the reaction with at least one thio-acid and at least one free radical initiator may be carried out at a temperature of from 0° C. to 150° C., more preferably of from 30° C. to 90° C., for a time of from 1 hour to 75 hours, more preferably of from 30 hours to 50 hours.

According to one preferred embodiment, the vinyl monomer which may be advantageously used in the process according to the present invention, may be selected from the vinyl monomers above reported.

According to one preferred embodiment, the vinyl monomer is used in an amount of from 0.1% by weight to 99% by weight, preferably of from 0.5% by weight to 90% by weight, with respect to the total weight of the surface-treated vulcanized rubber in a subdivided form and the vinyl monomer.

According to one preferred embodiment, the free radical initiator which may be advantageously used in the grafting step of the process according to the present invention, may be selected, for example, from: peroxide compounds, azo compounds, or mixtures thereof. Peroxide compounds are particularly preferred.

Specific examples of peroxide compounds which may be advantageously used are: dibenzoyl peroxide, t-butyl hydroperoxide, di-t-butyl peroxide, bis(2,4-dichloro-benzoyl)peroxide, bis-(4-chlorobenzoyl)peroxide, 1,1-di-t-butylperoxy-3,5,5-trimethylcycloexane, 2,2-di-t-butyl-peroxybutane, t-butylperoxybenzoate, n-butyl-4,4-di-t-butylperoxyvalerate, 2,5-dimethyl-2,5-di-t-butylperoxy-hexane, dicumyl peroxide, bis(t-butylperoxyisopropyl)-benzene, 3,3,6,6,9-hexamethyl-1,2,4,5-tetraoxacyclononane, 2,5-dimethyl-2,5-di-t-butylperoxy-hexyne-3, t-butylcumyl peroxide, ethyl-3,3-di-(t-butylperoxy)butyrate, t-butyl-peroxy-3,3,5-trimethylhexanoate, bis-(4-methylbenzoyl)-peroxide, or mixtures thereof. Dibenzoyl peroxide is particularly preferred.

Specific examples of azo compounds which may be advantageously used have been already disclosed above.

According to one preferred embodiment, the free radical initiator is used in an amount of from 0.001% by moles to 5% by moles, preferably of from 0.01% by moles to 2% by moles, with respect to the total moles of vinyl monomer.

According to one preferred embodiment, said grafting step may be carried out at a temperature of from 0° C. to 150° C., more preferably of from 50° C. to 95° C., for a time of from 1 hour to 48 hours, more preferably of from 15 hours to 30 hours.

Preferably, in order to improve the absorption of the vinyl monomer on the surface-treated vulcanized rubber in a subdivided form, the vinyl monomer may be dissolved in an inert solvent. Preferably, said inert solvent may be selected from: aromatic hydrocarbons (for example, benzene, toluene, ethylbenzene, xylene), alicyclic hydrocarbon (for example, cyclohexane), aliphatic hydrocarbons (for example, hexane, octane), ketones (for example, methyl ethyl ketone), esters (for example, ethyl acetate), ethers (for example, 1,4-dioxane), or mixtures thereof.

The solvent may be used in an amount of from 0% by weight to 30% by weight, preferably of from 5% by weight to 20% by weight, with respect to the total weight of the vinyl monomer.

Said grafting step may be carried out by conventional method such as, for example, bulk polymerization, solution polymerization, suspension polymerization, emulsion polymerization, bulk-suspension polymerization.

Particularly preferred, is a bulk polymerization or a bulk-suspension polymerization wherein a surface-treated vulcanized rubber in a subdivided form dissolved in a vinyl monomer is bulk-polymerized and then, if necessary, suspension-polymerized. The polymerization may be initiated, for example, by heating the system or by irradiating the system with light or radiations.

In the bulk-polymerization method which is advantageous in industrial manufacturing process, an inert solvent may be added. Inert solvents which may be advantageously used have been already disclosed above.

Said grafting step may be carried out under atmospheric pressure or under applied pressure, in an atmosphere of an inert gas such as, for example, nitrogen, helium, argon, preferably under a stream of an inert gas, more preferably under a nitrogen stream.

Generally, said grafting step is continued until the conversion of the vinyl monomer reaches 20% to 100%, preferably 25% to 90%.

Said grafting step may be carried out in any system known in the art such as, for example, a batch system, a semi-batch system or a continuous system. For example, the polymerization may be carried out according to a continuous polymerization method such as, for example, a multistage bath continuous polymerization method, a multistage column continuous polymerization method, or a combination thereof.

After completion of said grafting step, the obtained thermoplastic elastomeric material may be recovered in accordance with any methods known in the art such as, for example, by removing the unreacted monomer, the homopolymer, and the diluent solvent optionally present, by solvent extraction, or by heating under reduced pressure, or by extrusion by means of an extruder designed so as to remove volatile matter. Subsequently, the so obtained thermoplastic elastomeric material may be pelletized or powdered as needed.

Alternatively, the obtained thermoplastic elastomeric material may be recovered by a method such as separation by filtration or centrifugation, washed with water or with inert solvents, dried and subsequently pelletized or powdered as needed.

The pellets or powders may be either packaged for future use or used immediately in a process of forming a manufactured product.

As already reported above, the pellets or powders may be directly formed into manufactured products according to techniques known in the art for thermal processing of thermoplastic resin compositions. For example, compression molding, vacuum molding, injection molding, calendering, casting, extrusion, filament winding, laminating, rotational or slush molding, transfer molding, lay-up or contact molding, stamping, or combinations of these methods, may be used.

Alternatively, as already reported above, the obtained pellets or powder may be added as interface compatibilizing agent to other polymers, preferably to polymers having the same kind of polymeric chains. For example, the obtained thermoplastic elastomeric material in pellets or powder form, may be melt-mixed with polystyrene to be used as a polymer blend, or may be mixed or melt-mixed with a polymer other than polystyrene, said polymer being selected, for example, from: styrene-butadiene rubbers, polyphenylene ether resins, polycarbonates, polyesters, to be used as a polymer blend.

Therefore, according to a further aspect, the present invention also relates to the use of a thermoplastic elastomeric material according to the present invention in blends with other polymers.

To the obtained thermoplastic elastomeric material conventional additives such as stabilizers [for example, antioxidants (phenolic antioxidants, phosphoric antioxidants), ultraviolet ray absorber (thermostabilizers], flame-retardants, lubricants (for example, zinc stearate, calcium stearate, ethylene-bis-stearylamide), mold lubricants or parting agents, antistatic agents, fillers, colorants (for example, titanium oxide, red iron oxide, azo compounds, perylene, phthalocyanine, heterocyclic-series compounds), plasticizers and spreading agents (for example, polyethylene glycol, mineral oil), surface-modifying agents, or mixtures thereof, may be added.

According to a further aspect, the present invention also relates to a manufactured product comprising the thermoplastic elastomeric material above disclosed.

Said thermoplastic elastomeric material may be molded in sheet form and structural form designed and adaptable as packaging structures, housings, support structures, furnitures, molded articles, toys, architectural trims, and the like.

Moreover, said thermoplastic elastomeric material may also be used in order to make, for example, belts such as, conveyor belts, power belts or driving belts; flooring and footpaths which may be used for recreational area, for industrial area, for sport or safety surfaces; flooring tiles; mats such as, anti-static computer mats, automotive floor mats; mounting pads; shock absorbers sheetings; sound barriers; membrane protections; carpet underlay; automotive bumpers; wheel arch liner; seals such as, automotive door or window seals; o-rings; gaskets; watering systems; pipes or hoses materials; flower pots; building blocks; roofing materials; and the like.

The present invention will be further illustrated below by means of a number of preparation examples, which are given for purely indicative purposes and without any limitation of this invention.

### EXAMPLE 1

### Preparation of Surface-Treated Vulcanized Rubber in a Subdivided Form (Hydroxy Groups)

A vulcanized rubber (cryogenically ground waste rubber from scrap tyres (having an average diameter <0.1 mm (140 mesh)—Applied Cryogenics International AG) was extracted with boiling acetone in order to remove plasticizers, accelerators and other additives usually present in the vulcanized rubber obtained from scrap tyres and was subsequently dried under vacuum until constant weight.

10 g of the obtained vulcanized rubber and 50 ml of an H₂O/acetone solution (9/1 in volume), were added into a 500 ml flask. The mixture was stirred, at room temperature, for 12 hours.

Afterward, 200 ml of an aqueous solution of potassium permanganate (KMnO₄—10% by weight in distilled water) were added dropwise and the mixture was stirred, at room temperature, for 24 hours. After 24 hours the purple colour of the potassium permanganate disappeared indicating the completion of the reaction.

The formed by-product, manganese dioxide (MnO₂), was further oxidized by adding 10 ml (2 ml each time) of a hydrogen peroxide solution (30% in volume) with 1% in volume of sulphuric acid. The obtained solid product was then filtered and washed with water, then with acetone and finally with diethyl ether, until the filtrate was neutral. Subsequently, the solid product was dried under vacuum until constant weight: a vulcanized rubber with hydroxy groups on its surface was obtained.

### EXAMPLE 2

### Preparation of Surface-Treated Vulcanized Rubber in a Subdivided Form (Mercapto Groups)

2 g of the oxidized rubber obtained as disclosed in Example 1 and 100 ml of toluene were added into a 250 ml flask and the mixture was stirred, at room temperature, for 12 hours. Subsequently, 1.3 ml of 3-mercaptopropyltrimethoxysilane (Sigma-Aldrich) was added and the mixture was stirred, at 95° C., for 24 hours.

Then, the mixture was centrifugated and the obtained solid product was washed with toluene, then with acetone, then with diethyl ether and finally with pentane. Subsequently, the solid product was dried under vacuum until constant weight: a vulcanized rubber with mercapto groups on its surface was obtained.

### EXAMPLE 3

### Preparation of Surface-Treated Vulcanized Rubber in a Subdivided Form (Mercapto Groups)

5 g of vulcanized rubber (cryogenically ground waste rubber from scrap tyres (<0.1 mm (140 mesh)—Applied Cryogenics International AG) which was extracted as disclosed in Example 1 and 100 ml of toluene were added into a 500 ml flask. The mixture was stirred, at room temperature, for 12 hours.

Subsequently, 1.5 ml of thioacetic acid (Sigma-Aldrich) and 0.035 g of 2,2′-azobis(isobutyronitrile) (Sigma-Aldrich), were added. The mixture was heated to 75° C. and was maintained at said temperature, under stirring, for 48 hours.

Then, the mixture was centrifugated and the obtained solid product was washed with toluene, then with methanol and was subsequently dried under vacuum until constant weight.

30 ml of toluene were then added to the dried solid product (0.65 g) and the mixture was stirred, at room temperature, for 12 hours. Subsequently, 15 ml of a sodium hydroxide solution (1% in methanol), were added slowly and the mixture was stirred, at room temperature, for 3 hours. Then, 5 ml of a hydrochloric acid solution (1M solution) were added and the stirring, at room temperature, was continued for 30 minutes.

The obtained solid product was washed with water, filtered, washed with methanol, and finally dried until constant weight: a vulcanized rubber with mercapto groups on its surface was obtained.

### EXAMPLES 4-7

### Preparation of the Thermoplastic Material Comprising an Elastomeric Phase

The surface-treated vulcanized rubbers obtained as disclosed in Examples 1 and 2 were used.

For comparative purposes, a vulcanized rubber in a subdivided form as such (namely, not surface-treated), was extracted as disclosed in Example 1.

0.5 g of vulcanized rubber were added to a 50 ml glass tube under nitrogen stream and a solution of 9.5 g of styrene with dibenzoyl peroxide (the amount of dibenzoyl peroxide are given in Table 1 and is expressed as % by moles with respect to the total moles of the vinyl monomer) was then added. The mixture was stirred, at 85° C., for 24 hours.

The obtained thermoplastic elastomeric material was suspended in chloroform, precipitated in methanol and dried under vacuum until constant weight.

The grafting efficiency (Φ) of the styrene was determined as follows.

A sample of 1 g of the obtained thermoplastic elastomeric material was extracted in boiling chloroform for 8 hours in order to extract the ungrafted polystyrene. After the extraction, the thermoplastic elastomeric material was dried under vacuum until constant weight and conditioned at room temperature before weighting. The difference between the weight of the sample before the extraction and the weight of the sample after the extraction corresponds to the weight of the ungrafted polystyrene.

The grafting efficiency (Φ) was determined by means of the following formula:

$$( Φ ) = \frac{( WGV )}{( WTV )} \times 100$$

wherein:
WGV is the weight, expressed in grams (g), of the surface-grafted polystyrene;
WTV is the total weight, expressed in grams (g), of the polystyrene contained in the obtained thermoplastic elastomeric material.

The weight of the surface-grafted polystyrene (WGV) corresponds to the difference between the total weight of the polystyrene (WTV) and the weight of the ungrafted polystyrene which was determined as reported above.

The total weight of polystyrene (WTV), which corresponds to the sum between the weight of the surface-grafted polystyrene and the weight of the ungrafted polystyrene contained in the obtained thermoplastic elastomeric material, was determined by means of a gravimetric analysis by a mass balance. To this purpose the thermoplastic elastomeric material obtained as disclosed above, was suspended in chloroform, precipitated in methanol and dried under vacuum until constant weight and was weighted: the difference between the so obtained weight and the weight of the starting vulcanized rubber in a subdivided form used in order to obtain the corresponding thermoplastic elastomeric material, corresponds to the total weight of the polystyrene (WTV).

The Degree of Grafting (% DG) was determined by means of the following formula:

$$\% DG = \frac{( WAE - WRS )}{( WRS )} \times 100$$

wherein:
WAE is the weight, expressed in grams (g), of the obtained thermoplastic elastomeric material after extraction of the ungrafted polystyrene;
WRS is the weight, expressed in grams (g), of the vulcanized rubber in a subdivided form in the obtained thermoplastic elastomeric material.

The amount of the surface-grafted vinyl polymer was determined by means of the following formula:

$$\% of surface grafted vinyl polymer = \frac{( WGV )}{( WAE )} \times 100$$

wherein:
WGV is the weight, expressed in grams (g), of the surface-grafted polystyrene;
WAE is the weight, expressed in grams (g), of the obtained thermoplastic elastomeric material after extraction of the ungrafted polystyrene.

The obtained data are given in Table 1.

### EXAMPLE 8

### Preparation of the Thermoplastic Material Comprising an Elastomeric Phase

The surface-treated vulcanized rubber obtained as disclosed in Example 3 was used.

The preparation was carried out as disclosed in Example 1 the only difference being the amount of vulcanized rubber and of the styrene used. To this purpose, 0.3 g of vulcanized rubber were added to a 50 ml glass tube under nitrogen stream and a solution of 9.7 g of styrene with dibenzoyl peroxide (the amount of dibenzoyl peroxide are given in Table 1 and is expressed as % by moles with respect to the total moles of the vinyl monomer) was then added.

The data reported in Table 1 were obtained as disclosed in Example 1.

TABLE 1

| | | | WEIGHT OF | | | |
|---|---|---|---|---|---|---|
| | | TOTAL | UNGRAFTED | | | AMOUNT OF |
| | DIBENZOYL | WEIGHT OF | POLYSTYRENE | GRAFTING | DEGREE OF | GRAFTED |
| | PEROXIDE | POLYSTYRENE | HOMOPOLYMER | EFFICIENCY | GRAFTING | POLYSTYRENE |
| EXAMPLE | (% BY MOLES) | (g) | (g) | (Φ) | (% DG) | (%) |
| 4 (*) | 1 | 0.83 | 0.54 | 35.0 | 58 | 36.7 |
| 5 (*) | 2 | 0.68 | 0.48 | 29.0 | 40 | 28.6 |
| 6 | 1 | 1.61 | 0.84 | 48.0 | 154 | 60.7 |
| 7 | 1 | 3.91 | 1.72 | 56.0 | 438 | 81.4 |
| 8 | 2 | 1.12 | 0.55 | 51.0 | 190 | 65.5 |

(*): comparative.

Example 4: vulcanized rubber (cryogenically ground waste rubber from scrap tyres (average diameter <0.1 mm (140 mesh)—Applied Cryogenics International AG);

Example 5: vulcanized rubber (cryogenically ground waste rubber from scrap tyres (average diameter <0.1 mm (140 mesh)—Applied Cryogenics International AG);

Example 6: surface-treated vulcanized rubber from Example 1;

Example 7: surface-treated vulcanized rubber from Example 2;

Example 8: surface-treated vulcanized rubber from Example 3.

1-56. (canceled)

57. A thermoplastic elastomeric material comprising a vulcanized rubber in a subdivided form surface-grafted with at least one vinyl polymer, wherein the amount of said surface-grafted vinyl polymer is not lower than 60% by weight with respect to the total weight of the surface-grafted vinyl polymer and the vulcanized rubber in a subdivided form.

58. The thermoplastic elastomeric material according to claim 57, wherein the amount of said surface-grafted vinyl polymer is not lower than 70% by weight with respect to the total weight of the surface-grafted vinyl polymer and the vulcanized rubber in a subdivided form.

59. The thermoplastic elastomeric material according to claim 58, wherein the amount of said surface-grafted vinyl polymer is not lower than 80% by weight with respect to-the total weight of the surface-grafted vinyl polymer and the vulcanized rubber in a subdivided form.

60. The thermoplastic elastomeric material according claim 57, wherein said vinyl polymer has a degree of grafting (% DG) on the surface of said vulcanized rubber in a subdivided form not lower than 150%.

61. The thermoplastic elastomeric material according to claim 60, wherein said vinyl polymer has a degree of grafting (% DG) on the surface of said vulcanized rubber in a subdivided form of 160% to 600%.

62. The thermoplastic elastomeric material according to claim 61, wherein said vinyl polymer has a degree of grafting (% DG) on the surface of said vulcanized rubber in a subdivided form of 180% to 800%.

63. The thermoplastic elastomeric material according to claim 57, wherein said vinyl polymer is grafted onto the surface of the vulcanized rubber in a subdivided form by means of a sulfur bridge.

64. The thermoplastic elastomeric material according to claim 57, wherein the vulcanized rubber in a subdivided form is in the form of powder or granules having a particle size not higher than 10 mm.

65. The thermoplastic elastomeric material according to claim 57, wherein the vulcanized rubber in a subdivided form is in the form of powder or granules having a particle size not higher than 0.5 mm.

66. The thermoplastic elastomeric material according to claim 65, wherein the vulcanized rubber in a subdivided form is in the form of powder or granules having a particle size not higher than 0.2 mm.

67. The thermoplastic elastomeric material according to claim 66, wherein the vulcanized rubber in a subdivided form is in the form of powder or granules having a particle size not higher than 0.1 mm.

68. The thermoplastic elastomeric material according to claim 57, wherein the vulcanized rubber in a subdivided form comprises at least one crosslinked diene elastomeric polymer or copolymer of natural origin or comprises at least one crosslinked diene elastomeric polymer or copolymer obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

69. The thermoplastic elastomeric material according to claim 68, wherein the crosslinked diene elastomeric polymer or copolymer is selected from: cis-1,4-polyisoprene, 3,4-polyisoprene, polybutadiene, optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

70. The thermoplastic elastomeric material according to claim 57, wherein the vulcanized rubber in a subdivided form further comprises at least one crosslinked elastomeric polymer of one or more monoolefins with an olefinic comonomer or derivatives thereof.

71. The thermoplastic elastomeric material according to claim 70, wherein the crosslinked elastomeric polymer is selected from ethylene/propylene copolymers or ethylene/propylene/diene copolymers; polyisobutene; butyl rubbers; halobutyl rubbers, chlorobutyl or bromobutyl rubbers; or mixtures thereof.

72. The thermoplastic elastomeric material according to claim 57, wherein said vinyl polymer is obtained by means of a free radical polymerization of vinyl monomers.

73. The thermoplastic elastomeric material according to claim 72, wherein said vinyl monomers are selected from alkyl vinyl monomers, 2-hydroxyethyl(meth)acrylate, 2-hydroxypropyl(meth)acrylate, 2-ethylhexyl(meth)acrylate, butoxyethyl(meth)acrylate, cyclic vinyl monomers, tetrahydrofurfuryl(meth)acrylate; linear or branched alkyl(meth)acrylates, methyl(meth)acrylate, ethyl(meth)acrylate, butyl(meth)acrylate, octyl(meth)acrylate, decyl(meth)acrylate, tridecyl(meth)acrylate, stearyl(meth)acrylate, lauryl(meth)acrylate, isodecyl(meth)acrylate), n-hexyl(meth)-acrylate, cyclic(meth)acrylates, cyclohexyl(meth)acrylate, isobornyl(meth)acrylate; ethoxylated alkyl(meth)acrylates, methoxyethyl(meth)acrylate, ethoxyethyl(meth)acrylate, butoxyethyl(meth)acrylate, 2-(2-ethoxy)ethyl(meth)acrylate, dicyclopentenyl(meth)acrylate, diethylene glycol(meth)acrylate; ethoxy-diethylene glycol(meth)acrylate; benzyl(meth)acrylate; polyethylene glycol(meth)acrylate; polypropylene glycol(meth)acrylate; methoxypolyethylene glycol(meth)acrylate; methoxypolypropylene glycol(meth)acrylate); 2-phenoxyethyl(meth)acrylate; phenoxypolyethylene glycol(meth)acrylate; alkyl-phenoxyethyl(meth)acrylate, nonyl phenoxyethyl(meth)acrylate, alkylphenoxypolyalkylene glycol(meth)acrylate, 2-hydroxy-3-phenyloxypropyl(meth)-acrylate; tetra-hydrofurfuryloxypropylalkylene glycol(meth)acrylate, dicyclopentenyloxypolyalkylene glycol(meth)acrylate; polyfluoroalkyl(meth)acrylate; or mixtures thereof; or from aromatic vinyl monomers, styrene, o-methyl styrene; m-methylstyrene; p-methyl-styrene; 2,4-dimethylstyrene; ethylstyrene; p-t-butyl-styrene; α-methyl-styrene; α-methyl-p-methylstyrene; o-chlorostyrene; m-chlorostyrene; p-chlorostyrene; p-bromostyrene; 2-methyl-1,4-dichlorostyrene; 2,4-dibromo-styrene; vinylnaphthalene; or mixture thereof; or derivatives thereof, comprising styrene comonomers containing copolymerizable monomer as a substituent, acrylonitrile, maleic anhydride, methyl methacrylate, vinyl acetate, divinylbenzene, or mixtures thereof.

74. The thermoplastic elastomeric material according to claim 73, wherein said vinyl monomers are selected from methyl(meth)acrylate and styrene monomers.

75. The thermoplastic elastomeric material according to claim 74, wherein said vinyl monomer is styrene.

76. A process for manufacturing a thermoplastic elastomeric material, comprising the following steps:
surface treating a vulcanized rubber in a subdivided form in order to provide hydroxy and/or mercapto groups on its surface; and
grafting at least one vinyl monomer to said surface-treated vulcanized rubber in the presence of at least one free radical initiator so as to obtain a vinyl polymer grafted onto the surface of said vulcanized rubber in a subdivided form.

77. The process for manufacturing a thermoplastic elastomeric material according to claim 76, wherein said vulcanized rubber in a subdivided form is surface treated in order to provide mercapto groups on its surface.

78. The process for manufacturing a thermoplastic elastomeric material according to claim 76, wherein said vinyl polymer has a grafting efficiency on the surface of said vulcanized rubber not lower than 40%.

79. The process for manufacturing a thermoplastic elastomeric material according to claim 78, wherein said vinyl polymer has a grafting efficiency on the surface of said vulcanized rubber of 45% to 60%.

80. The process for manufacturing a thermoplastic elastomeric
material according to claim 79, wherein the grafting efficiency of said vinyl polymer has a grafting efficiency on the surface of said vulcanized rubber of 50% to 80%.

81. The process for manufacturing a thermoplastic elastomeric material according to claim 76, wherein the vulcanized rubber in a subdivided form:
is in the form of powder or granules having a particle size not higher than 10 mm; or
comprises at least one crosslinked diene elastomeric polymer or copolymer of natural origin or comprises at least one crosslinked diene elastomeric polymer or copolymer obtained by solution polymerization, emulsion polymerization or gas-phase polymerization of one or more conjugated diolefins, optionally blended with at least one comonomer selected from monovinylarenes and/or polar comonomers in an amount of not more than 60% by weight; or
further comprises at least one crosslinked elastomeric polymer of one or more monoolefins with an olefinic comonomer or derivatives thereof.

82. The process for manufacturing a thermoplastic elastomeric material according to claim 76, wherein the step of surface treating a vulcanized rubber in a subdivided form in order to provide hydroxy groups on its surface is carried out by dispersing said vulcanized rubber in a subdivided form in a mixture comprising water and an organic solvent with at least one oxidizing agent.

83. The process for manufacturing a thermoplastic elastomeric material according to claim 82, wherein the organic solvent is selected from ketones, acetone, alcohols, ethanol, methanol, ethers, tetrahydrofurane, dioxane, or mixtures thereof.

84. The process for manufacturing a thermoplastic elastomeric material according to claim 82, wherein the oxidizing agent is selected from potassium permanganate, hydrogen peroxide, osmium tetraoxide, hydrogen peroxide/urea complex, sodium percarbonate, sodium perchlorate, sodium perborate, potassium peroxymonosulfate, potassium permanganate/potassium periodate aqueous solution, or mixtures thereof.

85. The process for manufacturing a thermoplastic elastomeric material according to claim 82, wherein said surface treating step is carried out at a temperature of −15° C. to 50° C.

86. The process for manufacturing a thermoplastic elastomeric material according to claim 82, wherein said surface treating step is carried out for 1 hour to 48 hours.

87. The process for manufacturing a thermoplastic elastomeric material according to claim 82, wherein the oxidizing agent is used in an amount of 1% by weight to 50% by weight with respect to the total weight of the vulcanized rubber in a subdivided form.

88. The process for manufacturing a thermoplastic elastomeric material according to claim 76, wherein the surface treating step is carried out by reacting the surface treated vulcanized rubber in a subdivided form obtained by dispersing said vulcanized rubber in a subdivided form in a mixture comprising water and an organic solvent with at least one oxidizing agent in order to provide hydroxy groups on its surface, with at least one silane coupling agent in order to provide mercapto groups on its surface.

89. The process for manufacturing a thermoplastic elastomeric material according to claim 88, wherein the silane coupling agent is selected from compounds having the following structural formula (I):
(R)₃Si—CₙH₂ₙ—SH (I)
wherein the R groups, which may be identical or different, are selected from alkyl, alkoxy or aryloxy groups or from halogen atoms, on condition that at least one of the R groups is an alkoxy or aryloxy group; and n is an integer of 1 to 6 inclusive.

90. The process for manufacturing a thermoplastic elastomeric material according to claim 88, wherein the reaction with at least one coupling agent is carried out at a temperature of −10° C. to 150° C.

91. The process for manufacturing a thermoplastic elastomeric material according to claim 88, wherein the reaction with at least one coupling agent is carried out for 1 hour to 48 hours.

92. The process for manufacturing a thermoplastic elastomeric material according to claim 88, wherein the coupling agent is used in an amount of from 0.01% by weight to 10% by weight with respect to the total weight of the surface-treated vulcanized rubber.

93. The process for manufacturing a thermoplastic elastomeric material according to claim 76, wherein the step of surface treating a vulcanized rubber in a subdivided form in order to provide mercapto groups on its surface is carried out by reacting the same with at least one thio-acid having the following structural formula (II):
R₁—C(═O)—SH (II)
wherein R₁ is selected from alkyl, aryl, alkylaryl or arylalkyl groups, in the presence of at least one free radical initiator.

94. The process for manufacturing a thermoplastic elastomeric material according to claim 93, wherein the thio-acid is used in an amount of 0.01% by weight to 3% by weight with respect to the total weight of the vulcanized rubber in a subdivided form.

95. The process for manufacturing a thermoplastic elastomeric material according to claim 93, wherein the free radical initiator is selected from azo compounds having the following structural formula (III):
R₂—N═N—R₃ (III)
wherein R₂ and R₃, which may be identical or different, are selected from organic groups, aliphatic, cycloaliphatic, or aromatic groups; or linear or cyclic nitrile derivatives.

96. The process for manufacturing a thermoplastic elastomeric material according to claim 95, wherein the free radical initiator is used in an amount of 0.001% by weight to 10% by weight with respect to the total weight of the vulcanized rubber in a subdivided form.

97. The process for manufacturing a thermoplastic elastomeric material according to claim 93, wherein the reaction with at least one thio-acid and at least one free radical initiator is carried out at a temperature of 0° C. to 150° C.

98. The process for manufacturing a thermoplastic elastomeric material according to claim 93, wherein the reaction with at least one thio-acid and at least one free radical initiator is carried out for 1 hour to 75 hours.

99. The process for manufacturing a thermoplastic elastomeric material according to claim 76, wherein the vinyl monomer is selected from alkyl vinyl monomers, 2-hydroxyethyl(meth)acrylate, 2-hydroxypropyl(meth)acrylate, 2-ethylhexyl(meth)acrylate, butoxyethyl(meth)acrylate; cyclic vinyl monomers, tetrahydrofurfuryl(meth)acrylate; linear or branched alkyl(meth)acrylates, methyl(meth)acrylate, ethyl(meth)acrylate, butyl(meth)-acrylate, octyl(meth)acrylate, decyl(meth)acrylate, tridecyl(meth)acrylate, stearyl(meth)acrylate, lauryl(meth)acrylate, isodecyl(meth)acrylate), n-hexyl(meth)-acrylate; cyclic(meth)acrylates, cyclohexyl(meth)acrylate, isobornyl(meth)acrylate; ethoxylated alkyl(meth)acrylates, methoxyethyl(meth)acrylate, ethoxyethyl(meth)acrylate, butoxyethyl(meth)acrylate, 2-(2-ethoxy)ethyl(meth) acrylate; dicyclopentenyl(meth)-acrylate; diethylene glycol(meth)acrylate; ethoxy-diethylene glycol(meth)acrylate; benzyl(meth)acrylate; polyethylene glycol(meth)acrylate; polypropylene glycol(meth)acrylate; methoxypolyethylene glycol(meth)acrylate; methoxypolypropylene glycol(meth)acrylate; 2-phenoxyethyl(meth)acrylate; phenoxypolyethylene glycol(meth)acrylate; alkyl-phenoxyethyl(meth)acrylate, nonylphenoxyethyl(meth)acrylate; alkylphenoxypolyalkylene glycol(meth)acrylate; 2-hydroxy-3-phenyloxypropyl(meth)acrylate; tetra-hydrofurfuryloxypropylalkylene glycol(meth)acrylate; dicyclopentenyloxypolyalkylene glycol(meth)acrylate; polyfluoroalkyl(meth)acrylate; or mixtures thereof; or from aromatic vinyl monomers, styrene; o-methylstyrene; m-methylstyrene; p-methyl-styrene; 2,4-dimethylstyrene; ethylstyrene; p-t-butyl-styrene; α-methyl-styrene; α-methyl-p-methylstyrene; o-chlorostyrene; m-chlorostyrene; p-chlorostyrene; p-bromostyrene; 2-methyl-1,4-dichlorostyrene; 2,4-dibromo-styrene; vinylnaphthalene; or mixture thereof; or derivatives thereof comprising styrene comonomers containing copolymerizable monomer as a substituent, acrylonitrile, maleic anhydride, methyl methacrylate, vinyl acetate, divinylbenzene, or mixtures thereof.

100. The process for manufacturing a thermoplastic elastomeric material according to claim 76, wherein the vinyl monomer is used in an amount of 0.1% by weight to 99% by weight with respect to the total weight of the surface-treated vulcanized rubber in a subdivided form and the vinyl monomer.

101. The process for manufacturing a thermoplastic elastomeric material according to claim 76, wherein the grafting step is carried out in the presence of at least one free radical initiator selected from peroxide compounds, azo compounds, or mixtures thereof.

102. The process for manufacturing a thermoplastic elastomeric material according to claim 101, wherein the free radical initiator is used in an amount of 0.001% by moles to 5% by moles with respect to the total moles of vinyl monomer.

103. The process for manufacturing a thermoplastic elastomeric material according to claim 76, wherein said grafting step is carried out at a temperature of 0° C. to 150° C.

104. The process for manufacturing a thermoplastic elastomeric material according to claim 76, wherein said grafting step is carried out for 1 hour to 48 hours.

105. The process for manufacturing a thermoplastic elastomeric material according to claims 76, wherein the vinyl monomer is dissolved in an inert solvent selected from aromatic hydrocarbons, alicyclic hydrocarbon, aliphatic hydrocarbons, ketones, esters, ethers, or mixtures thereof.

106. The process for manufacturing a thermoplastic elastomeric material according to claim 105, wherein said inert solvent is used in an amount of 0% by weight to 30% by weight with respect to the total weight of the vinyl monomer.

107. A polymer blended with an interface compatibilizing agent wherein the interface compatibilizing agent is the thermoplastic elastomeric material according to claim 57.

108. The polymer according to claim 107, wherein said polymer is selected from polystyrene, styrene-butadiene rubbers, polyphenylene ether resins, polycarbonates and polyesters.

109. A manufactured product obtained by molding a thermoplastic elastomeric material according to claim 57.

110. A manufactured product comprising a thermoplastic elastomeric material according to claim 57.

111. The manufactured product according to claim 109, said manufactured product being selected from packaging structures, housings, support structures, furniture, molded articles, toys and architectural trims.

112. The manufactured product according to claim 109, wherein said manufactured product is selected from belts; flooring and footpaths; flooring tiles; mats; shock absorber sheetings; sound barriers; membrane protections; carpet underlay; automotive bumpers; wheel arch liner; seals; o-rings; gaskets for watering systems; pipe or hose materials; flower pots; building blocks; roofing materials; and geomembranes.
